(19) United States
(12) Patent Application Publication
(10) Pub. No.: US 2021/0186663 A1
(43) Pub. Date: Jun. 24, 2021

(54) Orthodontic Appliance for Malocclusion Correction

(71) Applicant: 3M INNOVATIVE PROPERTIES COMPANY, St Paul, MN (US)

(72) Inventor: Stephen R. Alexander, Stillwater, MN (US)

(21) Appl. No.: 17/252,407

(22) PCT Filed: Jun. 10, 2019
(86) PCT No.: PCT/IB2019/054817

§ 371 Date: Dec. 15, 2020

Related U.S. Application Data
(60) Provisional application No. 62/685,570, filed on Jun. 15, 2018.

(51) Int. Cl. A61C 7/36

(52) U.S. Cl. CPC A61C 7/36

(57) ABSTRACT

An orthodontic bite corrector for moving the relative positions of an upper dental arch and a lower dental arch, the orthodontic bite corrector comprising a post extending from a first support, the first support for connection to the first dental arch; a hub extending from a second support, the second support for connection to the second dental arch, and a ramp extending from the hub, the ramp including an occlusal end and a gingival end, where the hub is adjustable between a first fixed hub position and a second fixed hub position, and where the post is configured to slide along the ramp from the occlusal end to the gingival end when the upper dental arch and the lower dental arch are closed and methods of using such orthodontic bite corrector.

### TECHNICAL FIELD

The present disclosure relates to a device that is useful during the course of orthodontic treatment for correcting the position of one dental arch relative to the other. More specifically, the present disclosure concerns an orthodontic bite corrector for urging one of the dental arches either in a forward or rearward direction relative to the other dental arch.

### BACKGROUND

Orthodontic treatment is a specialized form of treatment within the field of dentistry, and involves movement of malpositioned teeth to orthodontically correct locations. Orthodontic treatment often greatly improves the aesthetic appearance of the patient's teeth. Orthodontic treatment can also improve the patient's occlusion, so that when the jaws are closed the upper teeth are in proper positions relative to the lower teeth.

The orthodontic treatment of some patients includes correction of the alignment of the upper dental arch to the lower dental arch. Certain patients have a condition referred to as a Class II malocclusion where the lower dental arch is located an excessive distance rearward of the upper dental arch when the jaws are closed. Other patients may have an opposite condition referred to as a Class III malocclusion where the lower dental arch is located forward of the upper dental arch when the jaws are closed.

### SUMMARY

In one aspect, provided is an orthodontic bite corrector for moving the relative positions of an upper dental arch and a lower dental arch, the orthodontic bite corrector comprising a post extending from a first support, the first support for connection to the first dental arch; a hub extending from a second support, the second support for connection to the second dental arch, and a ramp extending from the hub, the ramp including an occlusal end and a gingival end,
where the hub is adjustable between a first fixed hub position and a second fixed hub position, and where the post is configured to slide along the ramp from the occlusal end to the gingival end when the upper dental arch and the lower dental arch are closed. In some embodiments, the post includes a rounded head. In some embodiments, the post has a substantially circular cross-sectional profile. In some embodiments, the post comprises a ceramic material. In some embodiments, the first support comprises a metal selected from the group consisting of a gold alloy and stainless steel. In some embodiments, the hub includes a core, a cover, a washer, and a connector. In some embodiments, the core includes a notch. In some [symbol] cover includes a stop. In some embodiments, the washer includes a peg. In some [symbol] connector is a screw. In some embodiments, the hub comprises a metal selected from the group consisting of a gold alloy and stainless steel. In some embodiments, the ramp includes a channel In some embodiments, the ramp has an occlusal end and gingival end and is wider at the occlusal end. In some embodiments, the second support comprises a metal selected from the group consisting of a gold alloy and stainless steel. In some embodiments, at least one of the first support and the second support is an orthodontic band.

In another aspect, provided is method of correcting a malocclusion, the method comprising attaching the orthodontic bite corrector as described in the present disclosure to a patient's jaws. In some embodiments, the malocclusion is a Class II or a Class III malocclusion. In some embodiments, the orthodontic bite corrector is set at the first fixed hub position for a first period of time and is set at the second fixed hub position for a second period of time, where the second period of time is after the first period of time.

Features and advantages of the present disclosure will be further understood upon consideration of the detailed description as well as the appended claims.

### BRIEF DESCRIPTION OF THE DRAWINGS

FIG. 1 is a perspective view of a first embodiment of an appliance of the present disclosure attached to a subject's closed jaws.

FIG. 2 is a perspective view of the first embodiment of an appliance of the present disclosure attached to a subject's open jaws.

FIG. 3 is an exploded view of the appliance of FIGS. 1 and 2.

FIG. 4 is an exploded view from a buccal perspective of the hub of the appliance of FIGS. 1 and 2.

FIG. 5 is an exploded view from a lingual perspective of a portion of the hub of the appliance of FIGS. 1 and 2.

FIG. 6 is an exploded view of the appliance of FIGS. 1 and 2 showing the hub in a first position.

FIG. 7 is an exploded view of the appliance of FIGS. 1 and 2 showing the hub in a second position.

Repeated use of reference characters in the specification and drawings is intended to represent the same or analogous features or elements of the disclosure. It should be understood that numerous other modifications and embodiments can be devised by those skilled in the art, which fall within the scope and spirit of the principles of the disclosure. The figures may not be drawn to scale.

### DETAILED DESCRIPTION

As used herein:
“Mesial” means in a direction toward the center of the patient's curved dental arch. [symbol] a direction away from the center of the patient's curved dental arch. [symbol] in a direction toward the outer tips of the patient's teeth.
“Gingival” means in a direction toward the patient's gums or gingiva.
“Facial” means in a direction toward the patient's lips or cheeks.
“Labial” means in a direction toward the patient's lips.
“Buccal” means in a direction toward the patient's cheeks.
“Lingual” means in a direction toward the patient's tongue.

Known devices for malocclusion correction that are used in conjunction with clear-tray aligners commonly depend on the use of elastic bands and/or patient compliance for success. Provided are orthodontic appliances for malocclusion correction that overcome at least these problems. The disclosed orthodontic appliances do not include elastic bands, desirably allow for complete separation of the maxilla and mandible, and maintenance of the class correction forces both with and without clear-tray aligners inserted and without dependence on patient compliance. The disclosed orthodontic appliances also beneficially allow the dental practitioner to adjust corrective forces of the malocclusion correction appliance during treatment without having to completely disengage the appliance from the patient's jaws.

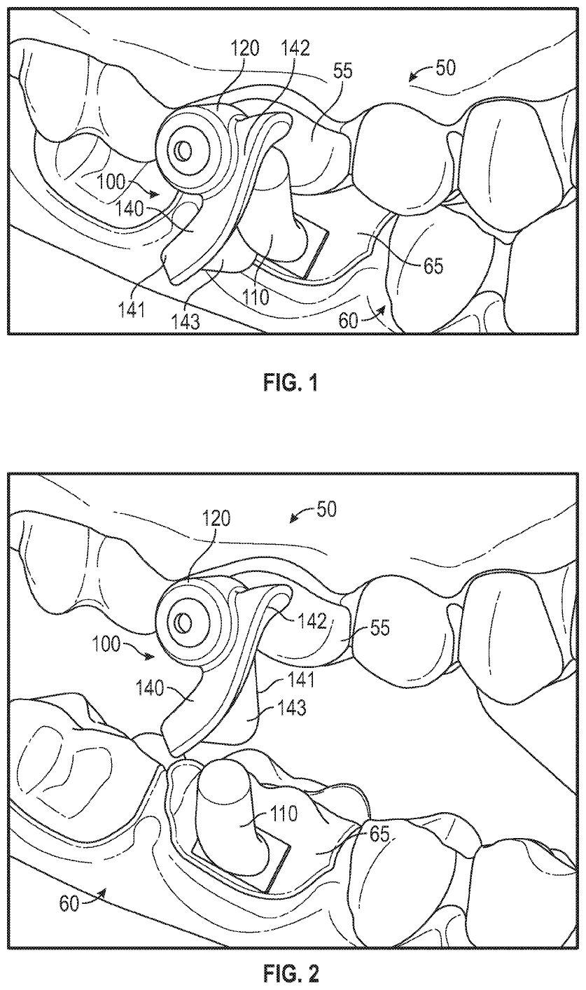

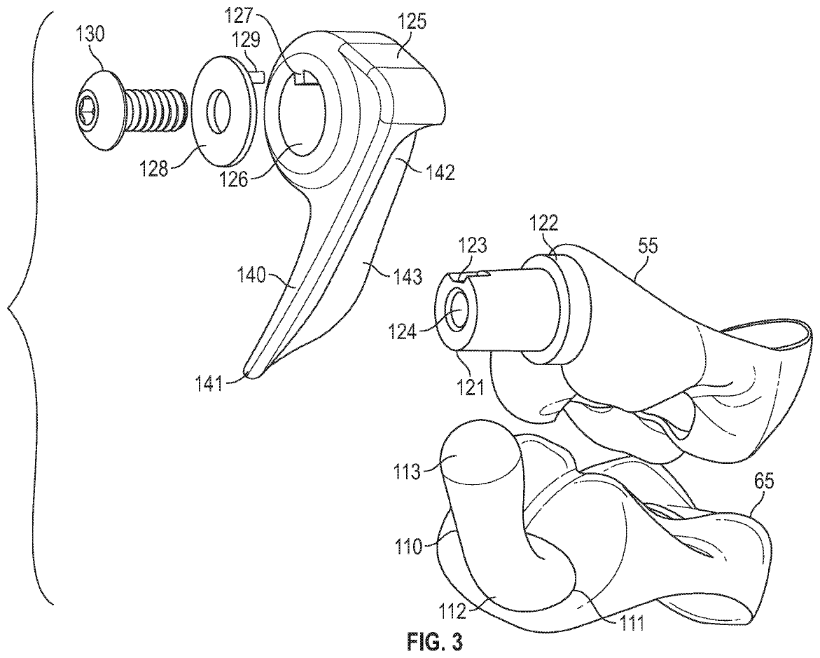

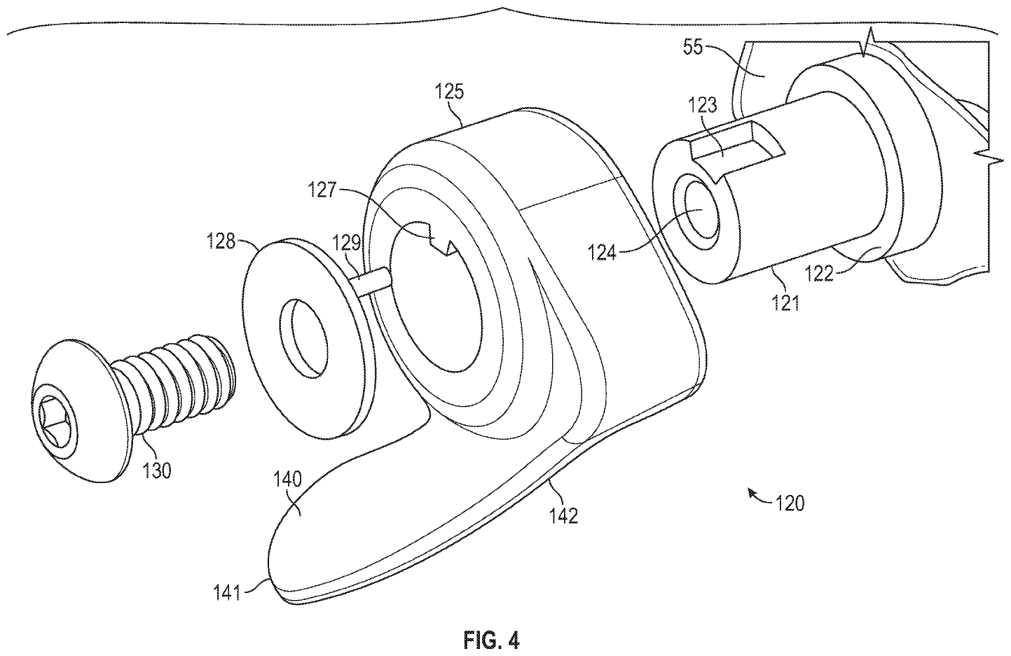

FIGS. 1 and 2 show an embodiment of an orthodontic bite corrector 100 for moving the relative positions of an upper dental arch 50 and a lower dental arch 60, the orthodontic bite corrector 100 including a post 110, a hub 120, and a ramp 140. FIGS. 1 and 2 show the orthodontic bite corrector 100 as it might be installed for repositioning the lower dental arch 60 relative to the upper dental arch 50. In particular, the force provided by the orthodontic bite corrector 100 according to the example shown in FIGS. 1 and 2 tends to move the lower dental arch 60 in a forward direction relative to the upper dental arch 50 when the patient's jaws are closed (FIG. 1) in order to correct what is known in the dental art as a Class II malocclusion. The same device, simply attached differently to the patient's teeth, e.g., with the ramp 140 extending in a mesial direction instead of a distal direction as shown, can also be used to move the lower dental arch 60 in a rearward direction relative to the upper dental arch 50 when the patient's jaws are closed in order to correct what is known in the dental art as a Class III malocclusion. FIG. 2 represents the orthodontic bite corrector 100 attached to a patient's open jaws and shows that the orthodontic bite corrector 100 of the present disclosure allows for complete separation of the maxilla and mandible. Complete separation of the maxilla allows, inter alia, for freedom of movement of the mandible in lateral directions and may therefore result in an improvement in patient experience during the term of treatment. FIGS. 3 shows an exploded view of the orthodontic bite corrector 100 of FIGS. 1 and 2.

Referring to FIG. 3, the orthodontic bite corrector 100 includes a post 110 extending from a first support 65, the first support 65 for connection to a first dental arch, for example, the lower dental arch 60 as shown in FIG. 3. It is also possible to connect the first support 65 to the upper dental arch 50 and may be the preferred connection in some circumstances, for example, when required to better accommodate [symbol] 3e of a patient's upper and lower dental arches. The post 110 is connected to the first [symbol] se 111 and extends laterally from the base 111, away from the outer surface of the first support 65 to a bend 112 and then extends in an occlusal direction, ending at a rounded head 113, the head 113 configured to slidably engage with the ramp 140 as described below. A cross section of the post 110 may have a substantially circular cross-sectional profile, but other geometries, e.g., oval, rectangular, triangular, are possible.

The first support 65 may be an orthodontic band such as, for example, a saddle band. The orthodontic band may comprise a metal, such as, for example, gold, a gold alloy, steel (e.g., stainless steel) or combinations thereof. As shown in FIGS. 1 and 2, the first support 65 may be cemented to a patient's lower first molar. In some embodiments, the first support 65 may be attached to a different tooth, e.g., a patient's second molar, or may be attached to more than one tooth, e.g., a patient's first and second molars.

The post 110 may be made of a material or combination of materials suitable for use in an orthodontic appliance and capable of withstanding forces exerted upon it as the patient repeatedly opens and closes the jaws during normal daily activities. In some embodiments the post 110 may include a metal, such as, for example, gold, a gold alloy, a steel (e.g., stainless steel) or combinations thereof. In other embodiments, the post 110 may include a ceramic material, such as, for example, a dental-grade ceramic. In some embodiments, the post 110 may include a metal and a ceramic material.

In some embodiments, the first support 65 and the post 110 can be formed as a single unit by methods known in the art, such as, for example, 3-dimensional (“3D”) printing, milling, casting, molding (e.g., injection molding, compression molding), scintering, or machining In some embodiments, the first support 65 and the post 110 can be formed separately and coupled using a variety of coupling means including, but not limited to, one or more of adhesives, cohesives, magnets, welding (e.g., sonic [e.g., ultrasonic] welding), a thermal bonding or heat sealing technique (e.g., heat and/or pressure applied to one or both of the components to be coupled), other suitable coupling means, or combinations thereof. The post 110 may be made of the same material or combination of materials as the first support 65 or may be made of a different material or combination of materials than the first support 65.

The orthodontic bite corrector 100 further includes the hub 120 extending from a second support 55, the second support 55 for connection to a second dental arch, for example, the upper dental arch 50 as shown in FIG. 3. It is also possible to connect the second support 55 to the lower dental arch 60, and is necessary to do so when the first support 65 has been or will be connected to the upper dental arch 50.

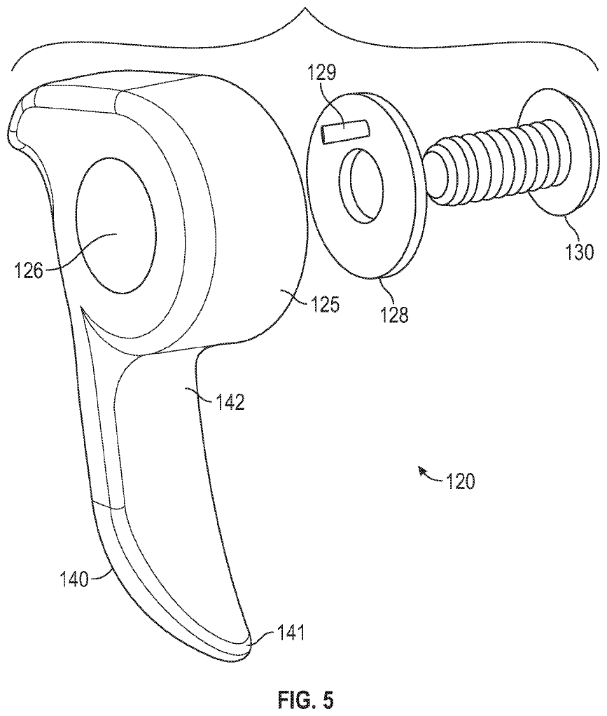

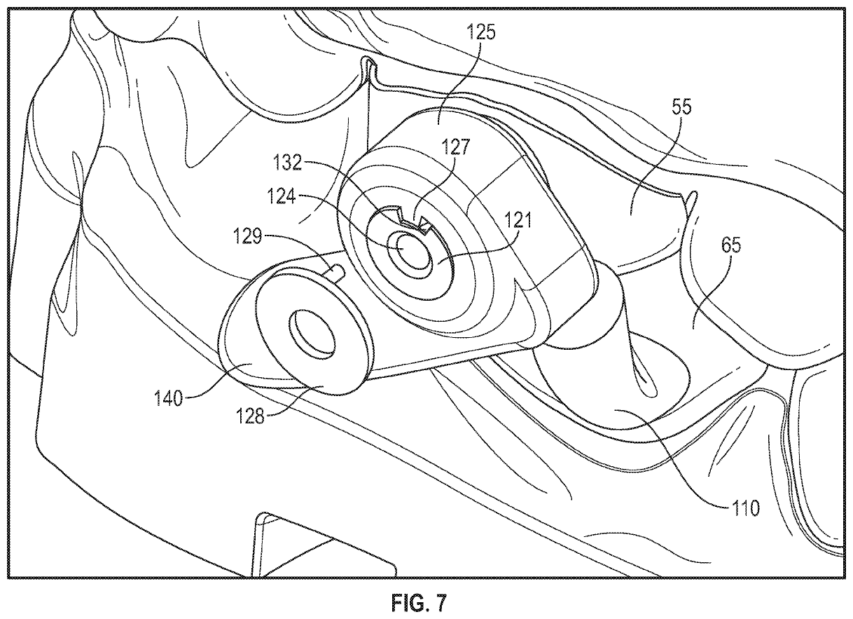

The second support 55 may be a device similar to or the same as the first support 65 or it may be another device capable of anchoring the hub 120 to the second dental arch. As shown in FIGS. 1 and 2, the second support 55 may be cemented to a patient's upper first molar, though the second support 55 may be attached to a different tooth, e.g., a patient's second molar. [symbol] [symbol] to FIG. 3, the hub 120 is connected to the second support 55 at a base 122 and extends base 122, away from the outer surface of the second support 55. The base 122 is connected to a core 121, the core 121 having a substantially cylindrical shape and configured to fit inside an opening 126 of a cover 125. The core 121 includes an aperture 124 configured to receive a connector 130, such as, for example, a screw as shown, though other connecting means known in the art may be used. As shown in FIG. 4, the core 121 includes a notch 123 on its outer curved surface, the notch 123 configured to cooperate with a stop 127 when the core 121 is inserted into the opening 126, the stop 127 positioned on the inside of the opening 126 and having a shape complementary to that of the notch 123. In the embodiment shown, the notch 123 has a substantially trapezoidal shape complementary to the trapezoidal profile of the stop 127, though different geometries for the notch 123 and stop 127 are contemplated, such as, for example, rectangular, circular, or oval. In the present disclosure the notch 123 is shown located on the gingival outer surface of the core 121, though it could be located at other positions on the outer surface of the core 121, e.g., the occlusal outer surface of the core 121. The hub 120 further includes a washer 128 that is positioned on the buccal face of the cover 125 and is held in contact with the cover 125 by the connector 130. The washer includes a peg 129 configured to cooperate with the stop 127 and hold the hub 120 and ramp 140 in one of two fixed positions, as shown in FIGS. 6 and 7. The peg 129 is shown as having a substantially cylindrical shape, but other geometries, e.g., rectangular, are contemplated.

Referring to FIG. 6, the core 121 may be positioned in the cover opening 126 such that the stop 127 abuts a mesial edge of the notch 123, providing a first position aperture 131 into which the peg 129 may be inserted, thereby holding the orthodontic bite corrector 100 in a first therapeutic position when the connector 130 is secured in the aperture 124. Referring to FIG. 7, the core 121 may be positioned in the cover opening 126 such that the stop 127 abuts a distal edge of the notch 123, providing a second position aperture 132 into which the peg 129 may be inserted, thereby holding the orthodontic bite corrector 100 in a second therapeutic position when the connector 130 is secured in the aperture 124. As can be seen in FIGS. 6 and 7, the ramp 140 is in a more distal orientation when the orthodontic bite corrector 100 in the first therapeutic position compared to when the ramp 140 is in the second therapeutic position. In some cases, for example, it may be appropriate for the practitioner to start treatment of a patient in need of Class II or Class III malocclusion correction with the orthodontic bite corrector 100 in the first therapeutic position and during treatment, as the patient's upper and lower jaws approach the desired relationship to each other, to adjust the orthodontic bite corrector 100 to the second therapeutic position to compensate for example, for movement of the jaws or remodeling of the temporomandibular joint.

The ramp 140 is connected to the hub 120 at a gingival end 142 of the ramp 140 and extends in a substantially occlusal-distal direction to an occlusal end 141. The ramp 140 includes a channel 143, the channel 143 configured to slidably engage with the head 113 of the post 110, the post 110 sliding along the ramp from the occlusal end 141 to the gingival end 142 when the upper dental arch and the lower dental arch are closed. As shown, the channel 143 may form a rounded trough, particularly when the [symbol] ost 110 is rounded, as the complementary rounded configurations of the head 113 and [symbol] flow for smooth sliding as the head 113 moves along the channel 143 when the upper dental arch and the lower dental arch are opened and closed and prevent the head 113 from disengaging along the lingual or buccal sides of the channel 143 as the head 113 travels up and down the length of the ramp 140.

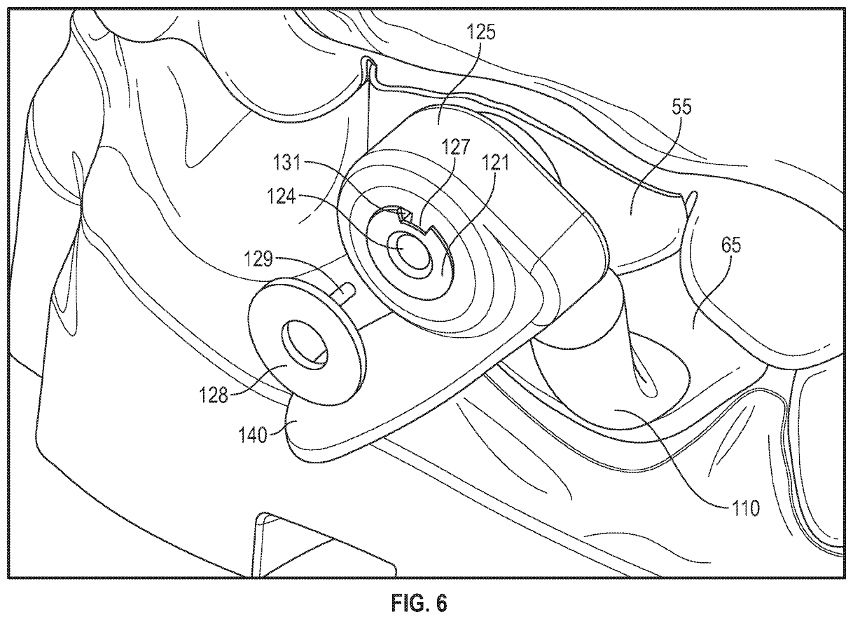

In some embodiments, and as shown in FIGS. 1-7, the ramp 140 may be wider at the occlusal end 141 than at the gingival end 142. The wider occlusal end 141 may enable the ramp 140 to reliably reengage upon closing of the patient's jaws (FIG. 1) after the post 110 and the ramp 140 disengage upon opening of the patient's jaws (FIG. 2).

The hub 120 and ramp 140 may be made of a material or combination of materials suitable for use in an orthodontic appliance and capable of withstanding forces exerted upon it and similar to or the same as those exerted on the post 110 as the patient repeatedly opens and closes the jaws during normal daily activities. In some embodiments the hub 120 and ramp 140 can be made of a metal, such as, for example, gold, a gold alloy, steel (e.g., stainless steel), or combinations thereof. In other embodiments, the hub 120 and ramp 140 may include a ceramic material, such as, for example, a dental-grade ceramic. In some embodiments, the post 110 may include a metal and a ceramic material. In some embodiments the hub 120 and the ramp 140 may be made of the same material or combination of materials. In some embodiments the hub 120 and the ramp 140 may be made of different materials or combination of materials. In some embodiments, it may be desirable for the post 110 to be made of a harder material or materials than the ramp 140, for example, the post 110 could be made of a ceramic material and the ramp 140 could be made of stainless steel, as the ramp 140 could be replaced easily in case of wear resulting from repeated contact between the post 110 and the ramp 140 during normal daily activities.

In some embodiments, the second support 55, the hub 120, and the ramp 140 can be formed as a single unit by methods known in the art, such as, for example, 3-dimensional (“3D”) printing, milling, casting, molding (e.g., injection molding, compression molding), scintering, or machining. In some embodiments, the second support 55 and the hub 120 and/or the ramp 140 can be formed separately and coupled using a variety of coupling means including, but not limited to, one or more of adhesives, cohesives, magnets, welding (e.g., sonic [e.g., ultrasonic] welding), a thermal bonding or heat sealing technique (e.g., heat and/or pressure applied to one or both of the components to be coupled), other suitable coupling means, or combinations thereof The hub 120 and/or ramp 140 may be made of the same material or combination of materials as the second support 55 or may be made of a different material or combination of materials than the second support 55.

An orthodontic bite corrector 100 of the present disclosure may be used in conjunction with clear-tray aligners or other orthodontic devices, and advantageously does not depend on the use of elastic bands and/or patient compliance for success in correcting the patient's Class II or Class III malocclusion. [symbol] of correcting a malocclusion according to the present disclosure can include attaching [symbol] to corrector 100 as described above to a patient's jaws. In some embodiments, the bite corrector 100 is set at the first fixed hub position for a first period of time, such as, for example, one week, one month, two months, three months, four months, five months, six months, seven months, eight months, nine months, or one year and is set at the second fixed hub position for a second period of time, such as, for example, one week, one month, two months, three months, four months, five months, six months, seven months, eight months, nine months, or one year, where the second period of time is after the first period of time.

### SELECT EMBODIMENTS OF THE PRESENT DISCLOSURE

Embodiment 1 is an orthodontic bite corrector for moving the relative positions of an upper dental arch and a lower dental arch, the orthodontic bite corrector comprising:
a post extending from a first support, the first support for connection to the first dental arch;
a hub extending from a second support, the second support for connection to the second dental arch, and
a ramp extending from the hub, the ramp including an occlusal end and a gingival end,
wherein the hub is adjustable between a first fixed hub position and a second fixed hub position, and wherein the post is configured to slide along the ramp from the occlusal end to the gingival end when the upper dental arch and the lower dental arch are closed.

Embodiment 2. The orthodontic bite corrector of embodiment 1, wherein the post includes a rounded head.

Embodiment 3 The orthodontic bite corrector of embodiment 1 or claim 2, wherein the post has a substantially circular cross-sectional profile.

Embodiment 4. The orthodontic bite corrector of any one of embodiments 1-3, wherein the post comprises a ceramic material.

Embodiment 5. The orthodontic bite corrector of any one of embodiments 1-4, wherein the first support comprises a metal selected from the group consisting of a gold alloy and stainless steel.

Embodiment 6. The orthodontic bite corrector of any one of embodiments 1-5, wherein the hub includes a core, a cover, a washer, and a connector.

Embodiment 7. The orthodontic bite corrector of embodiment 6, wherein the core includes a notch.

Embodiment 8. The orthodontic bite corrector of embodiment 6 or embodiment 7, wherein the cover includes a stop.

Embodiment 9. The orthodontic bite corrector of any one of embodiments 6-8, wherein the washer includes a peg.

Embodiment 10. The orthodontic bite corrector of any one of embodiments 6-9, wherein the connector is a screw. [symbol] The orthodontic bite corrector of any one of embodiments 1-10, wherein the hub [symbol] selected from the group consisting of a gold alloy and stainless steel.

Embodiment 12. The orthodontic bite corrector of any one of embodiments 1-11, wherein the ramp includes a channel

Embodiment 13. The orthodontic bite corrector of any one of embodiments 1-12, wherein the ramp has an occlusal end and gingival end and wherein the ramp is wider at the occlusal end.

Embodiment 14. The orthodontic bite corrector of any one of embodiments 1-13, wherein the second support comprises a metal selected from the group consisting of a gold alloy and stainless steel.

Embodiment 15. The orthodontic bite corrector of any one of embodiments 1-14, wherein at least one of the first support and the second support is an orthodontic band.

Embodiment 16 is a method of correcting a malocclusion, the method comprising: attaching the orthodontic bite corrector of any of embodiments 1-15 to a patient's jaws.

Embodiment 17. The method of claim 16, wherein the malocclusion is a Class II or a Class III malocclusion.

Embodiment 18. The method of embodiment 16 or embodiment 17, wherein the orthodontic bite corrector is set at the first fixed hub position for a first period of time and is set at the second fixed hub position for a second period of time, wherein the second period of time is after the first period of time.

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

What is claimed is:

1. An orthodontic bite corrector for moving the relative positions of an upper dental arch and a lower dental arch, the orthodontic bite corrector comprising:
a post extending from a first support, the first support for connection to the first dental arch;
a hub extending from a second support, the second support for connection to the second dental arch, and
a ramp extending from the hub, the ramp including an occlusal end and a gingival end,
wherein the hub is adjustable between a first fixed hub position and a second fixed hub position, and wherein the post is configured to slide along the ramp from the occlusal end to the gingival end when the upper dental arch and the lower dental arch are closed.

2. The orthodontic bite corrector of claim 1, wherein the post includes a rounded head.

3. The orthodontic bite corrector of claim 1, wherein the post has a substantially circular cross-sectional profile.

4. The orthodontic bite corrector of claim 1, wherein the post comprises a ceramic material.

5. The orthodontic bite corrector of claim 1, wherein the first support comprises a metal selected from the group consisting of a gold alloy and stainless steel.

6. The orthodontic bite corrector of claim 1, wherein the hub includes a core, a cover, a washer, and a connector.

7. The orthodontic bite corrector of claim 6, wherein the core includes a notch.

8. The orthodontic bite corrector of claim 6, wherein the cover includes a stop.

9. The orthodontic bite corrector of claim 6, wherein the washer includes a peg.

10. The orthodontic bite corrector of claim 6, wherein the connector is a screw.

11. The orthodontic bite corrector of claim 1, wherein the hub comprises a metal selected from the group consisting of a gold alloy and stainless steel.

12. The orthodontic bite corrector of claim 1, wherein the ramp includes a channel.

13. The orthodontic bite corrector of claim 1, wherein the ramp has an occlusal end and gingival end and wherein the ramp is wider at the occlusal end.

14. The orthodontic bite corrector of claim 1, wherein the second support comprises a metal selected from the group consisting of a gold alloy and stainless steel.

15. The orthodontic bite corrector of claim 1, wherein at least one of the first support and the second support is an orthodontic band.

16. A method of correcting a malocclusion, the method comprising:
attaching the orthodontic bite corrector of claim 1 to a patient's jaws.

17. The method of claim 16, wherein the malocclusion is a Class II or a Class III malocclusion.

18. The method of claim 16, wherein the orthodontic bite corrector is set at the first fixed hub position for a first period of time and is set at the second fixed hub position for a second period of time, wherein the second period of time is after the first period of time.
